(19) United States
(12) Patent Application Publication
(10) Pub. No.: US 2014/0113070 A1
(43) Pub. Date: Apr. 24, 2014

(54) PRIMER FOR IMPROVING THE ADHESION OF ADHESIVE TAPES ON PLASTICS AND METALS WHICH ARE DIFFICULT TO BOND

(71) Applicant: TESA SE, Hamburg (DE)

(72) Inventors: Uwe Schümann, Pinneberg (DE); Kirstin Weiland, Hamburg (DE); Kai Ellringmann, Hamburg (DE); Marco Kupsky, Quickborn (DE)

(73) Assignee: TESA SE, Hamburg (DE)

(21) Appl. No.: 14/119,060

(22) PCT Filed: Jun. 12, 2012
(86) PCT No.: PCT/EP2012/061129

§ 371 Date: Jan. 2, 2014

(30) Foreign Application Priority Data
Jun. 14, 2011 (DE) 10 2011 077 510.2

(51) Int. Cl. C09J 7/02

(52) U.S. Cl. CPC C09J 7/0217
USPC 427/208.4; 524/522; 523/437; 524/379

(57) ABSTRACT

Primer comprising a mixture, dissolved or dispersed in one or more solvents, of I) a pressure sensitive adhesive obtained by copolymerization of a) at least one acrylic ester of a linear primary alcohol, b) at least on acrylic ester of a branched, acyclic alcohol, and d) acrylic acid, II) at least one thermal crosslinker, and III) at least one chlorinated polyolefin.

This is a 371 of PCT/EP2012/061129, filed Jun. 12, 2012 (international filing date), claiming priority of German application 10 2011 077 510.2, filed Jun. 14, 2011.

The present invention relates to a primer composition for improving the adhesion of adhesive tapes to substrates which are difficult to bond, more particularly to galvanized steel, and also to olefin-based thermoplastic elastomers, such as PP/EPDM, for example.

### BACKGROUND OF THE INVENTION

Primers, often also called adhesion promoters, are widely known in the form of commercial products or from the technical literature. An overview of the compounds and classes of compound that can be used in primer formulations is found in J. Bielemann, Lackadditive (1998), section 4.3, pp. 114-129.

Primer compositions are disclosed in a host of patent specifications, but only a few specifications describe primers whose aim is to improve the adhesion of adhesive tapes.

Specification WO 2008/094721 A1 (U.S. 2010/035057 A1), in connection with adhesive tape applications, proposes a primer composition based on a maleic anhydride-modified polyolefin and on an organic diamine, the aim of this composition being to improve adhesion to polyolefin-based materials.

JP 2008-156566 A, for adhesive tape applications, discloses a primer composition based on an acidic acrylate polymer and on a fluorine-containing copolymer.

For improving the adhesion of an adhesive tape to substrates coated with melamine resin, WO 02/100961 A1 proposes a primer composition which comprises a graft copolymer of an acrylate copolymer, grafted with an amino alkyl group containing terminal primary amino groups, and further comprising an acrylate copolymer having carboxyl groups in the molecular chain, and a solvent.

WO 03/052021 A1 (U.S. Pat. No. 7,090,922) describes a primer composition which comprises a polydiorganosiloxane-polyurea having electron-rich groups and which may have the form of a primer, an adhesive, a pressure-sensitive adhesive, or another coating material. This primer composition as well is specified in connection with adhesive tape applications.

Specifications EP 833 865 B1 (U.S. Pat. No. 5,623,010), EP 833 866 B1 (U.S. Pat. No. 5,605,964), EP 739 383 B1, and U.S. Pat. No. 5,602,202 describe primer compositions that are based on mixtures of styrene/diene block copolymers or styrene/hydrogenated diene block copolymers and selected polyacrylates, and which are intended to improve the adhesion of double-sidedly pressure-sensitive foamed adhesive tapes to both low-energy and higher-energy surfaces.

For service as a primer layer within an adhesive tape, WO 03/035779 A (U.S. 2003/152,767) describes a primer composition based on a maleinized thermoplastic elastomer, an unhalogenated polyolefin, and a resin.

While the primer compositions described can be used to improve the adhesion of adhesive tapes to certain substrates, there is no known primer which on the one hand improves the adhesion of adhesive tapes to such an extent that the adhesive tapes can be removed from the substrate after a bonding time of three or more days only at the expense of its own destruction or the destruction of the substrate, and on the other hand still permits adhesive detachment and possibly repositioning of an adhesive tape for a certain, short time after application, as for example for a time of up to three minutes, particularly in respect of an adhesive tape which comprises a foamed, or foamlike elastomer layer and is designed for durable, strong adhesive bonds. In particular there is no known primer with which this effect in adhesive tape applications is achieved both to galvanized steel and to olefin-based thermoplastic elastomers, such as PP/EPDM, for example.

Besides the primers described in patent specifications, there are commercial products, such as the 3M Primer 94® or 4298 UV®, for example, which very effectively fulfill the function of improving the adhesion of adhesive tapes to substrates which are difficult to bond, more particularly both to apolar substrates such as plastics based on polypropylene/ethylene-propylene-diene monomers (PP/EPDM) and to metals such as galvanized steel. A disadvantage here, however, is that immediately after the application of an adhesive tape to the substrate coated with the primer, the adhesion developed is so strong that an adhesive tape, more particularly an adhesive tape which comprises a foamed or foamlike elastomer layer and is designed for durable, strong adhesive bonds, can, if incorrectly adhered, often no longer be nondestructively detached and possibly repositioned.

While in general a primer is expected to impart such optimum adhesion between the substrate and the adhesive tape that an attempt to redetach the adhesive tape causes splitting within the adhesive tape, in other words causes cohesive fracture and not an adhesive failure between pressure-sensitive adhesive and primer or between primer and substrate, the development of adhesion is nevertheless not to be so strong in all application scenarios, immediately after adhesive tape application, that the adhesive tape is already no longer nondestructively detachable at that moment. Instead, it would often be desirable for the development of adhesion to take place so slowly that sufficient time is still left for the adhesive tape, if adhered incorrectly, to be detached adhesively from the substrate.

There are commercial primers which allow nondestructive detachment of the adhesive tape, but in that case the adhesion, even some considerable time after the adhesive tape has been adhered to the substrate coated with such a primer, is so low that even after this time the adhesive tape can still be redetached adhesively, in other words nondestructively, there being numerous application scenarios, especially in industry, where this possibility is unwanted.

A further disadvantage of all known primers is that they do not ensure optimum protection against moisture undermining and against corrosion. In the event of relatively long-term storage periods under hot and humid conditions or under extreme fluctuating conditions, such storage periods frequently being required in the automotive, electronics, and solar industries, as for example incorporating temperatures from 60° C. to 90° C. in tandem with a relative humidity of 80% to 90%, moisture undermining generally takes place. In such cases the moisture migrates either between the substrate and the primer or between the primer and the pressure-sensitive adhesive of the adhesive tape, or between both. The consequence is that the adhesion of the adhesive tape is no longer optimum and it can be unwantedly detached adhesively. Moreover, there may be unwanted corrosion, as for example the formation of zinc oxide under the bond area in the case of a galvanized steel substrate.

It is an object of the invention to provide a primer for improving the adhesion of adhesive tapes in particular to galvanized steel and also to olefin-based thermoplastic elastomers. A particular advantage is the suitability for improving the adhesion of foamed or foamlike elastomeric adhesive tapes, more particularly those with a pressure-sensitive adhesive based on thermally crosslinked copolymers of acrylate esters and acrylic acid, in particular to galvanized steel and also to olefin-based thermoplastic elastomers, such as PP/EPDM, for example, but also to other substrates, more particularly plastics such as, for example, acrylonitrile/butadiene-styrene copolymers (ABS), polycarbonate (PC), polyvinyl chloride (PVC), or polypropylene (PP). Preferably during a period of up to three minutes after its application to the primer-treated substrate, the adhesive tape ought to be able to be redetached adhesively and optionally to be repositioned or at least to be able to be replaced by a new strip of adhesive tape. After a time of three or more than three days following adhesive tape application to the primer-coated substrate, the adhesive tape ought predominantly to be detachable only subject to destruction, in other words with internal adhesive-tape splitting, either by cohesive splitting within a layer of the adhesive tape, by adhesive detachment of a layer of the adhesive tape from another layer, or by splitting of pressure-sensitive adhesive. After a number of weeks of storage under hot and humid conditions or under fluctuating conditions, incorporating temperatures of 60° C. to 90° C. in conjunction with relative humidity of greater than or equal to 80% affecting the adhesive tape adhered to the primer-coated substrate, the adhesive tape ought to be detachable predominantly only at the expensive of its own destruction, and there ought to be no instances of moisture undermining, or at least fewer such instances than in the case with the presently known primers.

### SUMMARY OF THE INVENTION

The invention accordingly provides a primer comprising a mixture, in dispersion or solution in one or more solvents, of
I) a pressure-sensitive adhesive comprising at least one base polymer component obtainable by radical copolymerization of monomers below:
   a) at least one acrylic ester of a linear, primary alcohol having 2 to 10 carbon atoms in the alcohol alkyl radical,
   b) at least one acrylic ester of a branched, noncyclic alcohol having 4 to 12 carbon atoms inclusive in the alcohol alkyl radical,
   c) 8 to 15 mass percent of acrylic acid, based on the sum of the monomers,
   d) optionally up to 10 mass percent of other copolymerizable monomers, based on the sum of the monomers,
II) at least one thermal crosslinker based on a metal acetylacetonate, a metal alkoxide, or an alkoxy-metal acetylacetonate, and
III) at least one chlorinated polyolefin, which may optionally have been modified with an α,β-unsaturated carboxylic acid or anhydride thereof, more particularly with maleic anhydride and/or with an acrylate,
   where the concentration of the sum of the thermal crosslinkers, based on the sum of the base polymer components of the pressure-sensitive adhesive, is in the range of from 0.05 mass percent to 5.0 mass percent.

### DETAILED DESCRIPTION OF THE INVENTION

A primer for the purposes of this specification, in agreement with DIN EN ISO 4618, is a coating material for producing a prime coating. Generally speaking, a primer or coating material is applied to the surface of a substrate, after which a film is formed by evaporation of the solvent and/or by another chemical or physical curing or film-forming process, and a further, different substance, as for example a varnish, a paint, an adhesive, or an adhesive tape, can be subsequently applied to the film thus produced. Prerequisites for an adhesion-promoting effect on the part of a primer are firstly very good adhesion of the primer layer to the substrate, and secondly the likewise very good adhesion of the further, different substance to the produced primer layer to which said other substance is to be applied.

A solvent in the sense of this specification is any known liquid suitable for dissolving or at least finely dispersing the mixture of I), II), and III). Preferred solvents of the invention are organic solvents, such as, for example, alcohols, esters, ketones, aliphatic or aromatic hydrocarbons, and halogenated hydrocarbons, to cite but a few examples. Water or other inorganic solvents are likewise included by the concept of the invention.

A dispersed mixture for the purposes of this specification is a finely divided, homogeneous mixture. The degree of fine division and of homogeneity is not strictly defined, but must be sufficient that a coherent layer is formed after coating and that the size of the aggregates or agglomerates which are not dissolved at a molecular level is sufficiently low so as to ensure the function of the primer layer as an adhesion-promoting layer.

A pressure-sensitive adhesive—PSA—for the purposes of this specification, as usual within the general linguistic usage, is a substance which, in particular at room temperature, is permanently tacky and also adhesive. A characteristic of a PSA is that it can be applied to a substrate by pressure and remains adhering there, with no more detailed definition of the pressure to be applied or of the period of exposure to said pressure. In certain cases, depending on the precise nature of the PSA, on the temperature, on the atmospheric humidity, and on the substrate, a short-term, minimal pressure is sufficient, which does not go beyond a gentle contact for a brief moment, in order to obtain the adhesion effect; in other cases, a longer-term period of exposure to a high pressure may be necessary.

PSAs have particular, characteristic viscoelastic properties which give rise to the durable tack and adhesiveness.

One of their characteristics is that when they are mechanically deformed, both viscous flow processes and development of elastic resilience forces occur. In terms of their respective proportion, the two processes are in a defined ratio to one another, this ratio being dependent not only on the precise composition, structure, and degree of crosslinking of the PSA in question, but also on the rate and duration of the deformation, and on the temperature.

The proportional viscous flow is necessary for the attainment of adhesion. Only the viscous components, produced by macromolecules with relatively high mobility, allow effective wetting and effective flow onto the substrate to be bonded. A high viscous flow component results in a high pressure-sensitive tack (also called surface tack) and hence often also in a high bond strength. Highly crosslinked systems, crystalline polymers, or polymers that have undergone glasslike solidification are generally not pressure-sensitively adhesive, or are pressure-sensitively adhesive at least only to a small extent, owing to a lack of flowable components.

The proportional elastic resilience forces are necessary in order to achieve cohesion. They are produced, for example, by very long-chain macromolecules with a high degree of entanglement, and also by physically or chemically crosslinked macromolecules, and they allow the transmission of the forces which engage upon an adhesive bond. Their result is that an adhesive bond is able to withstand sufficiently, over a relatively long period of time, a long-term load acting on it, in the form, for example, of a long-term shearing load.

For more precise description and quantification of the degree of elastic and viscous components and also of the ratio of the components to one another, it is possible to employ the variables of storage modulus (G′) and loss modulus (G″) that can be determined by dynamic mechanical analysis (DMA). G′ is a measure of the elastic component, G″ a measure of the viscous component, of a substance. Both variables are dependent on the deformation frequency and the temperature.

The variables can be determined by means of a rheometer. In that case, the material under analysis is exposed, in a plate/plate arrangement, for example, to a sinusoidally oscillating shearing stress. In the case of instruments controlled by shear rate, the deformation is measured as a function of time, and the time offset of this deformation is measured relative to the introduction of the shearing stress. This time offset is referred to as phase angle δ.

The storage modulus G′ is defined as follows: G′=(τ/γ)·cos(δ) (τ=shear stress, γ=deformation, δ=phase angle=phase shift between shear stress vector and deformation vector). The definition of the loss modulus G″ runs: G″=(τ/γ)·sin(δ) (τ=shear stress, γ=deformation, δ=phase angle=phase shift between shear stress vector and deformation vector).

A substance is considered generally to be pressure-sensitively adhesive, and is defined for the purposes of the present specification as pressure-sensitively adhesive, if at room temperature, here by definition at 23° C., in the deformation frequency range from 10° to 10¹ rad/sec, G′ is at least partly in the range from 10³ to 10⁷ Pa and if G″ is likewise at least partly within this range. Partly means that at least one section of the G′ plot is situated within the window formed by the deformation frequency range of 10° to 10¹ rad/sec (abscissa) and also by the range of the G′ values from 10³ up to the 10⁷ Pa (ordinate), and if at least one section of the G″ plot is likewise situated within this window.

The essential feature of the PSA present in the primer of the invention is that this PSA comprises at least one base polymer component obtainable by radical copolymerization of monomers below:
I)a) at least one acrylic ester of a linear, primary alcohol having 2 to 10 carbon atoms in the alcohol alkyl radical,
I)b) at least one acrylic ester of a branched, noncyclic alcohol having 4 to 12 carbon atoms in the alcohol alkyl radical,
I)c) 8 to 15 mass percent of acrylic acid, based on the sum of the monomers,
I)d) optionally up to 10 mass percent of other copolymerizable monomers, based on the sum of the monomers,
   where the sum of components I)a) to I)d) advantageously—in the case of two or more base polymer components, in each case—makes up 100 mass percent of the base polymer component.

The at least one base polymer component, or, where there are two or more base polymer components present that are based on the (monomer) components I)a) to I)d), the sum of the base polymer components—ought to make up at least 90 mass percent, preferably at least 95 mass percent, more preferably at least 98 mass percent of the PSA [component I] and may make up up to 100 mass percent of the PSA; in other words, advantageously there is not more than 10 mass percent, preferably not more than 5 mass percent, more preferably not more than 2 mass percent of PSA constituents other than the base polymer components.

Further PSA constituents may be, for example, resins, plasticizers, stabilizers, rheological additives, fillers, initiators, catalysts, accelerators, and the like, of the kind known to the skilled person as additives for PSAs.

Very particular importance here is accorded to the fraction of acrylic acid, which is high at 8 to 15 mass percent. Acrylic acid is a “hard” comonomer. The higher the fraction of acrylic acid, the higher the anticipated glass transition temperature of the copolymer will be.

This has a great influence over the suitability of the copolymer as a base polymer for the PSA present in the primer. Through the copolymerization of very large amounts of acrylic acid, the range is readily entered of such a high copolymer glass transition temperature that said temperature comes close to the application temperature (in other words, in particular, room temperature) or even exceeds that temperature, and so the use as a base polymer for the PSA component for the primer is possibly no longer an option. Attempts are made to compensate this effect by using, as further comonomers, soft monomers—that is, monomers whose glass transition temperatures are low, in order to force the glass transition temperature of the copolymer back down again. For the calculation of the glass transition temperatures of comonomers, the prior art describes the Fox equation (E1) (cf. T. G. Fox, Bull. Am. Phys. Soc. 1 (1956) 123) as being applicable: In the equation (E1), n represents the serial number of the monomers used, Wₙ the mass fraction of the respective monomer n (mass percent), and Tg,n the respective glass transition temperature of the homopolymer of each of the monomers n, in K. This means that the glass transition temperature changes directly with the mass fraction of each of the comonomers used.

$$\frac{1}{{T}_{g}} = {\sum }_{n} \frac{{w}_{n}}{{T}_{g , n}} \qquad ( E 1 )$$

Accordingly, then, the skilled person would expect to be able to lower the glass transition temperature the furthest by copolymerizing, with the acrylic acid, only the kind of monomer whose corresponding homopolymer has the lowest glass transition temperature, and thus obtaining the copolymer with the best suitability as a base polymer component of a PSA that is intended to serve as a constituent of a primer.

Surprisingly it has been found that the predicted effect is not a satisfactory descriptor of the reality. It has been ascertained that a copolymer with a high amount of acrylic acid acquires the optimum suitability as a base polymer component of a PSA which serves as a constituent of a primer which achieves the stated object if as further comonomers there is at least one linear “soft” acrylic ester and at least one branched “soft” acrylic ester in substantial mass fractions. The essential feature of the PSA present in the primer of the invention, therefore, is that this PSA comprises at least one base polymer component obtainable by radical copolymerization of monomers below:
a) at least one acrylic ester of a linear, primary alcohol having 2 to 10 carbon atoms in the alcohol alkyl radical,
b) at least one acrylic ester of a branched, noncyclic alcohol having 4 to 12 carbon atoms in the alcohol alkyl radical,
c) 8 to 15 mass percent of acrylic acid, based on the sum of the monomers,
d) optionally up to 10 mass percent of other copolymerizable monomers, based on the sum of the monomers.

In one particularly preferred embodiment of the invention, the PSA comprises only one base polymer component, and with particular advantage the base polymer component is confined to components a) to c), meaning that the base polymer component is based on no other copolymerizable monomers apart from linear acrylic esters having 2 to 10 C atoms in the alcohol alkyl radical, branched noncyclic acrylic esters having 4 up to and including 12 carbon atoms in the alcohol alkyl radical, and 8 up to and including 15 mass percent of acrylic acid, based on the sum of the monomers. A feature of the PSA as a constituent of the primer of the invention is that there is no need for the presence of other—more particularly, softening—comonomers and components beyond those specified. Thus, for example, there is no need at all for comonomers with cyclic hydrocarbon units.

Linear alkyl acid esters having 2 to 10 C atoms in the alkyl radical are ethyl acrylate, n-propyl acrylate, n-butyl acrylate, n-pentyl acrylate, n-hexyl acrylate, n-heptyl acrylate, n-octyl acrylate, n-nonyl acrylate, n-decyl acrylate.

Branched noncyclic acrylic esters having 4 up to and including 12 carbon atoms in the alcohol alkyl radical are preferably selected from the group consisting of 2-ethylhexyl acrylate (EHA), 2-propylheptyl acrylate, isooctyl acrylate, isobutyl acrylate, isoamyl acrylate and/or isodecyl acrylate. It has been found particularly advantageous if use is made as branched noncyclic acrylic esters of 2-ethylhexyl acrylate (EHA), 2-propylheptyl acrylate and/or isooctyl acrylate (more specifically: the acrylic esters in which the alcohol component derives from a mixture of primary isooctanols, in other words from alcohols of the kind obtainable from an isoheptene mixture by hydroformylation and subsequent hydrogenation).

Very preferable is a PSA whose base polymer is based on precisely one monomer of type a), one monomer of type b), and acrylic acid with the type a) monomer selected being more preferably n-butyl acrylate and with the type b) monomer selected being more preferably 2-ethylhexyl acrylate.

The suitability within the desired application range can be adjusted outstandingly via the fraction of acrylic acid in the base polymer component. With an increasing fraction of acrylic acid, there is an increase in the ease of immediate redetachability, but a decrease to some extent in the strength of the durable development of adhesion.

As further copolymerizable monomers used optionally at up to 10 mass percent, it is possible, without particular restriction, to use all of the radically polymerizable, C═C double bond-containing monomers or monomer mixtures that are known to the skilled person. Monomers for this that are stated as examples are as follows: methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, lauryl acrylate, n-undecyl acrylate, stearyl acrylate, tridecyl acrylate, benhenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, maleic anhydride, hydroxyethyl acrylate, hydroxypropyl acrylate, hydroxyethyl methacrylate, hydroxypropyl methacrylate, 6-hydroxyhexyl methacrylate, allyl alcohol, glycidyl acrylate, glycidyl methacrylate, 2-butoxyethyl acrylate, 2-butoxyethyl methacrylate, methyl 3-methoxyacrylate, 3-methoxybutyl acrylate, phenoxyethyl acrylate, phenoxyethyl methacrylate, 2-phenoxyethyl methacrylate, butyl diglycol methacrylate, ethylene glycol acrylate, ethylene glycol monomethylacrylate, methoxy polyethylene glycol methacrylate 350, methoxy polyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethylaminopropylacrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide, and also N,N-dialkyl-substituted amides, such as, for example, N,N-dimethylacrylamide, N,N-dimethylmethacrylamide, N-benzylacrylamides, N-isopropylacrylamide, N-tert-butylacrylamide, N-tert-octylacrylamide, N-methylolacrylamide, N-methylolmethacrylamide, acrylonitrile, methacrylonitrile, vinyl ethers, such as vinyl methyl ether, ethyl vinyl ether, vinyl isobutyl ether, vinyl esters, such as vinyl acetate, vinyl chloride, vinyl halides, vinylidene chloride, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene. Macromonomers such as 2-polystyrene-ethyl methacrylate (molecular weight MW from 4000 to 13000 g/mol), poly(methyl methacrylate)ethyl methacrylate (MW from 2000 to 8000 g/mol).

On varying the ratio of linear acrylic ester to branched, noncyclic acrylic ester it has emerged that the desired effect of the adhesive redetachability of the adhesive tape during a period of up to three minutes after application to the primer-treated substrate, and the objective promotion of adhesion after a time of three or more than three days after adhesive tape application to the primer-coated substrate, is present optimally when the ratio of the sum of the acrylic esters of a linear, primary alcohol to the sum of the acrylic esters of a branched, noncyclic alcohol is in the range from 10:90 inclusive up to 90:10 inclusive mass fractions, preferably from 20:80 inclusive to 80:20 inclusive. Deficit fractions both of linear acrylic ester component and of branched acrylic ester component lead in certain cases, depending on the particular adhesive tape used, to a reduced adhesion-promoting effect on the part of the primer.

The above observations (acrylic acid fraction, ratio of the components to one another) apply in principle to all stated linear acrylic esters and branched noncyclic acrylic esters.

In one advantageous embodiment of the PSA as a constituent of the primer of the invention, the base polymer component makes up at least 90 mass percent, preferably at least 95 mass percent, more preferably at least 98 mass percent of the PSA, or the base polymer components in total make up at least 90 mass percent, preferably at least 95 mass percent, more preferably at least 98 mass percent of the PSA, when there is more than one base polymer present. In one particularly advantageous embodiment, the PSA is composed exclusively of the crosslinked base polymer component or of the crosslinked base polymer components.

It has also emerged that the objective promotion of adhesion after a time of three or more than three days following adhesive tape application to the primer-coated substrate is present optimally when the primer is free from block copolymers of the polystyrene/polydiene or polystyrene/hydrogenated polydiene type. Block copolymers of the polystyrene/polydiene or polystyrene/hydrogenated polydiene type, for the purposes of this specification, are all polymers whose molecules consist of interlinked blocks of polystyrene and polydiene units or of hydrogenated or partially hydrogenated polydiene units. Typical examples of polydiene units and of hydrogenated or partially hydrogenated polydiene units are polybutadiene blocks, polyisoprene blocks, ethylene/butylene blocks, or ethylene/propylene blocks.

In accordance with the invention the primer comprises at least one thermal crosslinker based on a metal acetylacetonate, a metal alkoxide, or an alkoxy-metal acetylacetonate, where the concentration of the sum of the thermal crosslinkers, based on the sum of the base polymer components of the PSA, is between 0.05 mass percent and 5.0 mass percent inclusive. Lower concentrations lead to inadequate crosslinking on the part of the PSA, which is manifested in an adhesive redetachability of the adhesive tape after a relatively long bonding period. Higher concentrations lead to excessive crosslinking of the PSA, which is likewise manifested in adhesive redetachability of the adhesive tape after a relatively long bonding period.

The term “thermal crosslinker” refers to the fact that the crosslinker enters into, or initiates, the chemical crosslinking reaction or, where appropriate, the crosslinking reactions as a result of temperature exposure and not as a result of radiation exposure. The crosslinking reactions in this invention are therefore initiated neither by actinic radiation nor by ionizing radiation such as, for instance, UV rays, X-rays, or electron beams. The temperature at which the chemical crosslinking reactions begin or are initiated may be room temperature or even below. The crosslinking reaction starts after the evaporation of the solvent. In order to prevent the mixture, more particularly the polyacrylate PSA, undergoing crosslinking while it is still in the solution, an alcohol, more particularly isopropanol, is added advantageously to the solution. Alternatively it is also possible to add small amounts of acetylacetone or other complexing agents that are easy to eliminate, or the solution may be diluted very highly. Preferred concentrations of the mixture in the solvent or the two or more solvents are between 0.1 and a maximum of 30 mass percent, more preferably between 0.5 and 20 mass percent, very preferably between 1.0 and 10 mass percent.

A metal acetylacetonate for the purposes of this invention is a metal chelate with the enolate anion of acetylacetone as ligand. The IUPAC name for acetylacetone is pentane-2,4-dione. A metal alkoxide for the purposes of the invention is a metal alcoholate, in other words a compound composed of a metal cation and an alcoholate anion. Examples of alcoholates frequently used industrially are methanolate, ethanolate, isopropanolate, tert-butanolate. An alkoxy-metal acetylacetonate means a complex compound composed of a metal cation and at least two different ligands, one of the ligands being an alcoholate anion and another ligand being the enolate anion of acetylacetone. Synonyms for an alkoxy-metal acetylacetonate are metal alkoxide acetylacetonate or metal acetylacetone alkoxide. All of the stated metal compounds may carry additional, further ligands, without departing the concept of the invention. Preferred metals are titanium, aluminum, zirconium, zinc, and iron. A particularly preferred compound is titanium diisopropoxide bis(acetylacetonate).

A chlorinated polyolefin is understood in this invention to be a polyolefin which has been chlorinated. The polyolefin may be, for example, polypropylene or polyethylene, or a copolymer or blend of polypropylene and polyethylene. The chlorinating may have been done in solvents or dispersions or by direct exposure to gaseous chlorine. The chlorinated polyolefin may have been modified by being optionally functionalized with an α,β-unsaturated carboxylic acid or anhydride thereof, more particularly with maleic anhydride, and/or with acrylate monomers in a grafting reaction, and the grafting reaction may have taken place before or after the chlorination. Both in their unmodified forms and in their modified forms as described, chlorinated polyolefins are state of the art and known as adhesion promoters in all of the stated forms.

In one advantageous embodiment of the primer of the invention, the primer further comprises one or more known epoxy resins. By epoxy resins here are meant all noncrosslinked oligomers which are solid or liquid at room temperature, are soluble in suitable solvents, and carry two or more epoxide groups. Suitable epoxy resins include for example all known such resins based on bisphenol A and/or bisphenol F, epoxy-phenol novolaks, epoxy-cresol novolaks, dicyclopentadiene-phenol novolaks, cycloaliphatic epoxy resins, and also epoxy resins containing ester groups or amino groups. The concentration of the sum of the epoxy resins in the mixture is not more than 12 mass percent, preferably not more than 6 mass percent, more preferably not more than 3 mass percent.

In another advantageous embodiment of the primer of the invention, the primer further comprises one or more known styrene acrylate resins.

By styrene acrylate resins are meant all noncrosslinked resins which are solid or liquid at room temperature and are soluble in suitable solvents and are composed at least of styrene and acrylic acid, methacrylic acid, acrylic esters and/or methacrylic esters. Preferred styrene acrylate resins contain hydroxyl groups.

In another advantageous embodiment of the primer of the invention, the primer further comprises one or more known organofunctional silanes. An organofunctional silane is understood in this specification to encompass compounds of the general formula (R¹O)₃Si—R²X or (R¹O)₂(R³)Si—R²X. Typical examples of the substituent (R¹O) are methoxy, ethoxy, 2-methoxyethoxy, or acetoxy groups. The substituent R³ is typically a methyl group. Typical suitable substituents R²X are the groups 3-glycidyloxypropyl, vinyl, methyacryloyloxymethyl, 3-methacryloyloxypropyl, methyl, isooctyle, hexadecyl, cyclohexyl, or phenyl, to give but a few examples.

In another advantageous embodiment of the primer of the invention, the primer further comprises one or more known fluorescent optical brighteners. The function of the fluorescent optical brightener is to identify a substrate that has been primed. Without optical identification it is frequently difficult to tell a primed substrate from an unprimed substrate, since the thickness in which a primer is applied is generally very low and hence barely visible optically. One known fluorescent optical brightener is 2,5-thiophenediylbis(5-tert-butyl-1,3-benzoxazole), CAS No. 7128-64-5, available commercially under the trade name Tinopal OB®.

Primers with the composition as above have excellent adhesion to PP/EPDM in particular, but also to many other plastics, such as, for example, ABS, PC, PVC, or PP, and also, equally, to galvanized steel as well. Adhesive tapes with polar PSAs more particularly with PSAs based on thermally crosslinked copolymers of acrylic esters and acrylic acid, adhere excellently to the primer. The force of adhesion of the adhesive tapes to the primer, surprisingly, is developed only relatively slowly, and so the adhesive tapes can still be adhesively detached for a period of up to about three minutes following their application. The adhesive detachability during this period, in conjunction with excellent adhesion after a bonding time of more than three days, is a novelty with respect to the prior art. The excellent adhesion after a bonding time of more than three days is apparent from the fact that the adhesive tape is then detachable predominantly only subject to destruction, in other words with internal splitting of the adhesive tape. After a number of weeks of storage under hot and humid conditions or under fluctuating conditions, including temperatures from 60° to 90° C., in conjunction with relative humidity of greater than or equal to 80%, for the adhesive tape adhered to the primer-coated substrate, the adhesive tape can predominantly be detached only subject to its own destruction. Moisture undermining is absent or is at least less marked than is the case with the currently known primers without primer.

The intention with the following examples is to describe the invention in more detail, without wishing thereby to restrict the invention.

The test methods below were used to provide brief characterization of the specimens produced in accordance with the invention:

### Dynamic Mechanical Analysis (DMA) for Determining the Storage Modulus G′ and the Loss Modulus G″

The PSAs were characterized by determination of the storage modulus G′ and loss modulus G″ by means of dynamic mechanical analysis (DMA).

The measurements were made using the DSR 200 N shear stress-controlled rheometer from Rheometric Scientific in an oscillation test with a sinusoidally oscillating shearing stress in a plate/plate arrangement. The storage modulus G′ and the loss modulus G″ were determined in a frequency sweep from 10⁻¹ to 10² rad/sec at a temperature of 23° C. G′ and G″ are defined as follows:

G′=τ/γ·cos(δ) (τ=shear stress, γ=deformation, δ=phase angle=phase shift between shear stress vector and deformation vector).
G″=τ/γ·sin(δ) (τ=shear stress, γ=deformation, δ=phase angle=phase shift between shear stress vector and deformation vector).

The definition for the angular frequency is as follows: ω=2π·f (f=frequency). The unit is rad/sec.

The thickness of the PSA samples measured was always between 0.9 and 1.1 mm (1+/−0.1 mm). The PSA samples were produced by coating out the PSAs described later on below on a double-sidedly siliconized polyester film (release liner), evaporating the solvent at 70°, and piling up the resulting 100 μm coats on one another until a thickness of about 1 mm was reached. The sample diameter was 25 mm in each case. Preliminary tension was applied with a load of 3N. For all of the measurements, the stress of the sample specimens was 2500 Pa.

### Bond Strength

The bond strength was determined in accordance with PSTC-101 at room temperature. In line with this method, the primer was first applied thinly to the substrate. This was done by brush application of the primer to the substrate. Following evaporation of the solvent, the adhesive strip under measurement (the adhesive tape) was applied (adhered) to the substrate now bearing the primer in a layer thickness of approximately 3 μm to 5 μm. To effect this application, a strip of the adhesive tape in a defined width (standard: 20 mm) was bonded to the primer-coated substrate, with dimensions of 50 mm×125 mm×1.1 mm, by rolling over it ten times with a 5 kg steel roller.

The time between the last rolling of the adhesive tape and the peel removal was as follows: a) 30 minutes; b) 3 days. The peel angle was 90° in each case and the peel rate 300 mm/min. The force required for peel removal is the bond strength, which is reported in the unit N/cm and thus relates to a standardized adhesive tape width of 1 cm. Alongside the bond strength, the nature of adhesive bond failure was ascertained. The adhesive strips measured were reinforced on the reverse with a polyester film that was 23 μm thick and had undergone incipient etching with trichloroacetic acid. All measurements were conducted in a controlled-climate space at 23° C. and 50% relative humidity.

### Redetachability

The redetachability was likewise determined in accordance with PSTC-101 at room temperature. According to this method, the primer was first applied thinly to the substrate. This was done by brush application of the primer to the substrate. Following evaporation of the solvent, the adhesive strip under measurement (the adhesive tape) was applied (adhered) to the substrate now bearing the primer in a layer thickness of approximately 3 μm to 5 μm. This was done by bonding a strip of the adhesive tape in a defined width (standard: 20 mm) to the primer-coated substrate with dimensions of 50 mm×125 mm×1.1 mm, by rolling once with a 5 kg steel roller.

The time between the rolling of the adhesive tape and the peel removal was one minute in each case. The peel angle was 90° in each case, and the peel rate 30 mm/min. The nature of adhesive bond failure was ascertained.

### Shear Test

The shear test took place in accordance with the test specification PSTC-107. According to this method, the primer was first applied thinly to the substrate. This was done by brush application of the primer to the substrate. Following evaporation of the solvent, the adhesive strip under measurement (the adhesive tape) was applied to the substrate now bearing the primer in a layer thickness of approximately 3 μm to 5 μm, pressed on twice with a 2 kg weight, and then, after a defined time, exposed to a constant shearing load. The time between the second pressing of the adhesive tape and the peel removal was as follows: a) 30 seconds; b) 30 minutes. The nature of adhesive tape failure and the holding power, in minutes, were ascertained.

The bond area was 13×20 mm in each case. The shearing load on this bond area was 1 kg. Measurement took place at room temperature (23° C.). The adhesive strips measured were reinforced on the reverse with a polyester film which had a thickness of 23 μm and had been incipiently etched with trichloroacetic acid.

### Conditioned Storage

The assemblies comprising the substrate coated with the primer of the invention and the adhesive tape adhered to that substrate were subjected to storage under selected climatic conditions, in order to determine the climatic robustness of the bond.

Storage a): two-week storage under conditions of 85° C. and 85% relative humidity
Storage b): two-week alternating storage with cycles of 4 hours −40° C., 4 hours heating/cooling, 4 hours 80° C./80% relative humidity.

After the end of the storage period, the samples, which were reinforced on the reverse with a polyester film having a thickness of 23 μm thick and having been incipiently etched with trichloroacetic acid, were subjected to the bond strength test with a peel angle of 90° in each case and with a peel rate of 300 mm/min, in a controlled-climatic space at 23° C. and 50% relative humidity.

### Static Glass Transition Temperature

The static glass transition temperature was determined via dynamic scanning calorimetry in accordance with DIN 53765. The figures for the glass transition temperature T_{g} refer to the glass transformation temperature value T_{g} in accordance with DIN 53765:1994-03, unless indicated otherwise in any specific case. Heating curves run with a heating rate of 10 K/min. The specimens are measured in Al crucibles with a perforated lid under a nitrogen atmosphere. Evaluation takes place on the second heating curve. A glass transition temperature is evident as an inflection point on the thermogram.

### Molecular Weights

The average molecular weight M_{w} and the average molecular weight Mₙ, and the polydispersity D, were determined by means of gel permeation chromatography (GPC). The eluent used was THF with 0.1 vol % of trifluoroacetic acid. Measurement took place at 25° C. The preliminary column used was a PSS-SDV, 5 μm, 10³ Å (10⁻⁷ m), ID 8.0 mm. Separation took place using the columns PSS-SDV, 5 μm, 10³ Å, (10⁻⁷ m), 10⁵ Å (10⁻⁵ m), and 10⁶ Å (10⁻⁴ m), each with ID 8.0 mm×300 mm. The sample concentration was 4 g/l, the flow rate 1.0 ml per minute. Measurement took place against PMMA standards.

### Solids Content

The solids content is a measure of the fraction of unvaporizable constituents in a polymer solution. It is determined gravimetrically, with the solution being weighed, the vaporizable fractions then being evaporated off in a drying cabinet at 120° C. for 2 hours, and the residue being weighed again.

K value (Fikentscher)

The K value is a measure of the average molecular size of high-polymer compounds. For the measurement, one percent strength (1 g/100 ml) toluenic polymer solutions were prepared and their kinematic viscosities were determined by means of a Vogel-Ossag viscometer. Standardization to the viscosity of toluene gives the relative viscosity, from which the K value can be calculated by the method of Fikentscher (Polymer 8/1967, 381 ff.).

The substrates used (to which the primer was applied first of all, followed by the adhesive tape being adhered thereto) were as follows:
a) PP/EPDM, (designation: HX TRC 135X/4 Black), (from Basell Bayreuth Chemie GmbH); PP/EPDM=blend of polypropylene and EPDM; EPDM=ethylene-propylene-diene rubber
b) Hot dip galvanized steel (from DX51 D+2275), (from Rocholl GmbH)
c) ABS (acrylonitrile-butadiene-styrene copolymer), (from Rocholl GmbH)
d) PC (polycarbonate), (from Rocholl GmbH)
e) PVC (polyvinyl chloride), (from Rocholl GmbH)
f) PP (polypropylene), (from Rocholl GmbH)

The adhesive tapes (test adhesive tapes) with which the primer was tested were based on polyacrylate PSAs. These polyacrylate PSAs were prepared using the following raw materials:

| | | Manufacturer or | |
|---|---|---|---|
| Chemical compound | Trade name | supplier | CAS No. |
| Bis(4-tert-butylcyclohexyl) | Perkadox 16 | Akzo Nobel | 15520-11-3 |
| peroxydicarbonate | | | |
| 2,2′-Azobis(2- | Vazo 64 | DuPont | 78-67-1 |
| methylpropionitrile), AlBN | | | |
| 2,2′-Azobis(2- | Vazo 67 | DuPont | 13472-08-7 |
| methylbutyronitrile) | | | |
| Pentaerythritol tetraglycidyl | Polypox R16 | UPPC AG | 3126-63-4 |
| ether | | | |
| 3,4-Epoxycyclohexylmethyl | Uvacure 1500 | Cytec Industries Inc. | 2386-87-0 |
| 3,4- | | | |
| epoxycyclohexanecarboxylate | | | |
| Triethylenetetramine | Epikure 925 | Hexion Speciality | 112-24-3 |
| | | Chemicals | |
| Microballoons (MB) | Expancel 051 DU 40 | Expancel Nobel | |
| (dry unexpanded microspheres, | | Industries | |
| diameter 9 to 15 μm, expansion onset | | | |
| temperature 106 to 111° C., TMA density | | | |
| ≦25 kg/m³) | | | |
| Terpene-phenolic resin | Dertophene T110 | DRT resins | 25359-84-6 |
| (softening point 110° C.; M_{w} = 500 to | | | |
| 800 g/mol; D = 1.50) | | | |
| Acrylic acid n-butyl ester | n-butyl acrylate | Rohm & Haas | 141-32-2 |
| Acrylic acid | acrylic acid, pure | BASF | 79-10-7 |
| 2-Ethylhexyl acrylate | | Brenntag | 103-11-7 |
| Methyl acrylate | | BASF | 96-33-3 |

The expansion capacity of the microballoons can be described through the determination of the TMA density [kg/m³] (Stare Thermal Analysis System from Mettler Toledo; heating rate 20° C./min). The TMA density here is the minimum achievable density at a defined temperature Tₘₐₓ under atmospheric pressure before the microballoons collapse.

The softening point of the resins is determined in accordance with DIN ISO 4625.

Furthermore, the following solvents were used for preparing the polyacrylate PSAs contained in the test adhesive tapes:

| Designation | CAS No. | Manufacturer |
|---|---|---|
| Special-boiling-point spirit 60/95 or | 64742-49-0 | Shell, Exxon |
| naphtha (crude oil), hydrogen-treated, | | |
| light | | |
| Acetone | 67-64-1 | Shell |
| Isopropanol | 67-63-0 | Shell |

### Test Adhesive Tape 1

An example polyacrylate PSA 1 for producing the test adhesive tape 1 was prepared as follows: A reactor conventional for radical polymerizations was charged with 54.4 kg of 2-ethylhexyl acrylate, 20.0 kg of methyl acrylate, 5.6 kg of acrylic acid, and 53.3 kg of acetone/isopropanol (94:6). After nitrogen gas had been passed through the reactor for 45 minutes, with stirring, the reactor was heated to 58° C. and 40 g of Vazo 67, in solution in 400 g of acetone, were added. Thereafter the external heating bath was heated to 75° C. and the reaction was carried out constantly at this external temperature. After one hour a further 40 g of Vazo 67, in solution in 400 g of acetone, were added, and after four hours the batch was diluted with 10 kg of acetone/isopropanol mixture (94:6).

After five hours and again after seven hours, initiation was repeated with 120 g each time of bis(4-tert-butylcyclohexyl) peroxydicarbonate, in each case in solution in 400 g of acetone. After a reaction time of 22 hours, the polymerization was discontinued and the batch was cooled to room temperature. The product had a solids content of 55.9% and was freed from the solvent in a concentrating extruder under reduced pressure (residual solvent content ≦0.3 mass percent). The resulting polyacrylate had a K value of 58.8, an average molecular weight of Mw=746000 g/mol, a polydispersity of D (Mw/Mn)=8.9, and a static glass transition temperature of T_{g}=−35.6° C.

This base polymer was melted in a feeder-extruder (single-screw conveying extruder from TROESTER GmbH & Co. Kg, Germany) and in the form of a polymer melt was conveyed with said extruder, via a heatable hose, into a planetary roller extruder from Entex (Bochum). The melted resin Dertophene T 110 was then added via a metering port, to give the melt a resin concentration of 28.3 mass percent. Additionally, the crosslinker Polypox R16 was added. Its concentration in the melt was 0.14 mass percent. All components were mixed to give a homogeneous polymer melt.

Using a melt pump and a heatable hose, the polymer melt was transferred to a twin-screw extruder (from Berstorff). There the accelerator Epikure 925 was added. Its concentration in the melt was 0.14 mass percent. The entire polymer mixture was then freed from all gas inclusions in a vacuum dome under a pressure of 175 mbar. After the vacuum zone, the microballoons were metered in and were incorporated homogeneously into the polymer mixture by means of a mixing element. Their concentration in the melt was 0.7 mass percent. The resulting melt mixture was transferred into a die.

Following exit from the die, in other words after a drop in pressure, the incorporated microballoons underwent expansion, with the drop in pressure producing shear-free cooling of the polymer composition. This gave a foamed polyacrylate PSA, which was subsequently shaped to web form in a thickness of 0.8 mm by means of a roll calendar, and was lined with a double-sidedly siliconized release film (50 μm, polyester), while the chemical crosslinking reaction proceeded. After winding, the film was stored at room temperature for four weeks before being used further for primer testing. The wound film is test adhesive tape 1.

### Test Adhesive Tape 2

An example polyacrylate PSA 2A for producing the test adhesive tape 2 was prepared as follows: A reactor conventional for radical polymerizations was charged with 30.0 kg of 2-ethylhexyl acrylate, 67.0 kg of butyl acrylate, 3.0 kg of acrylic acid, and 66.7 kg of acetone/isopropanol (96:4). After nitrogen gas had been passed through the reactor for 45 minutes, with stirring, the reactor was heated to 58° C. and 50 g of Vazo 67, in solution in 500 g of acetone, were added. Thereafter the external heating bath was heated to 70° C. and the reaction was carried out constantly at this external temperature. After one hour a further 50 g of Vazo 67, in solution in 500 g of acetone, were added, and after two hours the batch was diluted with 10 kg of acetone/isopropanol mixture (96:4). After 5.5 hours, 150 g of bis(4-tert-butylcyclohexyl) peroxydicarbonate, in solution in 500 g of acetone, were added; after 6 hours 30 minutes, dilution was repeated with 10 kg of acetone/isopropanol mixture (96:4). After 7 hours, a further 150 g of bis(4-tert-butylcyclohexyl) peroxydicarbonate, in solution in 500 g of acetone, were added, and the heating bath was set to a temperature of 60° C.

After a reaction time of 22 hours, the polymerization was discontinued and the batch was cooled to room temperature. The product had a solids content of 50.2% and was dried. The resulting polyacrylate had a K value of 75.2, an average molecular weight of Mw=1370000 g/mol, a polydispersity of D (Mw/Mn)=17.13, and a static glass transition temperature of T_{g}=−38.0° C.

This base polymer was melted in a feeder-extruder (single-screw conveying extruder from TROESTER GmbH & Co. Kg, Germany) and in the form of a polymer melt was conveyed with said extruder, via a heatable hose, into a planetary roller extruder from Entex (Bochum). Additionally, the crosslinker Polypox R16 was then added via a metering port. Its concentration in the melt was 0.22 mass percent. All components were mixed to give a homogeneous polymer melt.

Using a melt pump and a heatable hose, the polymer melt was transferred to a twin-screw extruder (from Berstorff). There the accelerator Epikure 925 was added. Its concentration in the melt was 0.14 mass percent. The entire polymer mixture was then freed from all gas inclusions in a vacuum dome under a pressure of 175 mbar. After the vacuum zone, the microballoons were metered in and were incorporated homogeneously into the polymer mixture by means of a mixing element. Their concentration in the melt was 2.0 mass percent. The resulting melt mixture was transferred into a die.

Following exit from the die, in other words after a drop in pressure, the incorporated microballoons underwent expansion, with the drop in pressure producing shear-free cooling of the polymer composition. This gave the foamed polyacrylate PSA 2A, which was subsequently shaped to web form in a thickness of 0.8 mm by means of a roll calendar, and was lined with a double-sidedly siliconized release film (50 μm, polyester), while the chemical crosslinking reaction proceeded. The wound film was stored at room temperature for a day before further processing (see below).

An example polyacrylate PSA 2B for producing the two outer layers of the three-layer test adhesive tape 2 was prepared as follows:

A 100 l glass reactor conventional for radical polymerizations was charged with 4.8 kg of acrylic acid, 11.6 kg of butyl acrylate, 23.6 kg of 2-ethylhexyl acrylate, and 26.7 kg of acetone/special-boiling-point spirit 60/95 (1:1). After nitrogen gas had been passed through the reactor for 45 minutes, with stirring, the reactor was heated to 58° C. and 30 g of AIBN were added. Thereafter the external heating bath was heated to 75° C. and the reaction was carried out constantly at this external temperature. After a reaction time of 1 hour, a further 30 g of AIBN were added. After 4 hours and again after 8 hours, dilution was carried out with 10.0 kg each time of acetone/special-boiling-point spirit 60/95 (1:1) mixture. To reduce the residual initiators, 90 g portions of bis(4-tert-butylcyclohexyl) peroxydicarbonate were added after 8 hours and again after 10 hours. After a reaction time of 24 hours, the reaction was discontinued and the batch was cooled to room temperature. The polyacrylate was subsequently blended with 0.2 mass percent of the crosslinker Uvacure® 1500, then diluted to a solids content of 30% with acetone, and subsequently coated from solution onto a double-sidedly siliconized release film (50 μm, polyester). (Coating speed 2.5 m/min, drying tunnel 15 m, temperatures zone 1: 40° C., zone 2: 70° C., zone 3: 95° C., zone 4: 105° C.). The thickness was 50 μm. After winding, the film was stored at room temperature for 2 days, before being used further to produce the test adhesive tape 2.

A film of the polyacrylate PSA 2B was laminated onto both sides of the foamed film of polyacrylate PSA 2A. Immediately prior to the laminating of the film of polyacrylate PSA 2B onto the foamed film of polyacrylate PSA 2A, the respective surface of the film of polyacrylate PSA 2A to be laminated was subjected to air corona pretreatment with a corona dose of 35 Wmin/m². Prior to the second lamination, the double-sidedly siliconized release film of the foamed polyacrylate PSA 2A was lined. After the second lamination, one of the double-sidedly siliconized release films of the two foamed polyacrylate PSAs 2B was lined as well. The 3-layer assembly composed of polyacrylate PSA 2B/polyacrylate PSA 2A/polyacrylate PSA 2B was wound up and stored at room temperature for four weeks before being further used for primer testing. The wound assembly is test adhesive tape 2.

The polyacrylate PSAs described by way of example in terms of their composition and production methodology are described comprehensively in DE 10 2010 062 669 (U.S. 2011/0281964 A1). The disclosure content of that specification is incorporated explicitly into the disclosure content of this invention.

To prepare the polyacrylate PSA present in the primer in accordance with the invention, the following raw materials were used:

| Chemical compound | Trade name | Manufacturer | CAS No. |
|---|---|---|---|
| Bis(4-tert- | Perkadox 16 | Akzo Nobel | 15520-11-3 |
| butylcyclohexyl) | | | |
| peroxydicarbonate | | | |
| 2,2′-Azobis(2- | Vazo 64 | DuPont | 78-67-1 |
| methylpropionitrile), | | | |
| AlBN | | | |
| Acrylic acid n-butyl | n-butyl acrylate | Rohm & Haas | 141-32-2 |
| ester | | | |
| Acrylic acid | acrylic acid, pure | BASF | 79-10-7 |
| 2-Ethylhexyl acrylate | | Brenntag | 103-11-7 |
| Isobornyl acrylate | Ageflex IBOA | Ciba | 5888-33-5 |

In addition, the following solvents were used for preparing the polyacrylate PSAs present in the test adhesive tapes:

| Designation | CAS No. | Manufacturer |
|---|---|---|
| Special-boiling-point spirit 60/95 or | 64742-49-0 | Shell, Exxon |
| naphtha (crude oil), hydrogen-treated, | | |
| light | | |
| Acetone | 67-64-1 | Shell |

Example polyacrylate PSAs for use as a constituent in the primer of the invention were prepared as follows:

### Primer PSA 1

A 100 l glass reactor conventional for radical polymerizations was charged with 4.8 kg of acrylic acid, 11.6 kg of butyl acrylate, 23.6 kg of 2-ethylhexyl acrylate, and 26.7 kg of acetone/special-boiling-point spirit 60/95 (1:1). After nitrogen gas had been passed through the reactor for 45 minutes, with stirring, the reactor was heated to 58° C. and 30 g of AIBN were added. Thereafter the external heating bath was heated to 75° C. and the reaction was carried out constantly at this external temperature. After a reaction time of 1 hour, a further 30 g of AIBN were added. After 4 hours and again after 8 hours, dilution took place with 10.0 kg of acetone/special-boiling-point spirit 60/95 (1:1) mixture each time. To reduce the residual initiators, 90 g portions of bis(4-tert-butylcyclohexyl) peroxydicarbonate were added after 8 hours and again after 10 hours. After a reaction time of 24 hours, the reaction was discontinued and the batch was cooled to room temperature. The polyacrylate was diluted to a solids content of 30 mass percent with acetone.

### Primer PSA 2

A 100 l glass reactor conventional for radical polymerizations was charged with 3.2 kg of acrylic acid, 13.6 kg of butyl acrylate, 23.2 kg of 2-ethylhexyl acrylate, and 26.7 kg of acetone/special-boiling-point spirit 60/95 (1:1). After nitrogen gas had been passed through the reactor for 45 minutes, with stirring, the reactor was heated to 58° C. and 30 g of AIBN were added. Thereafter the external heating bath was heated to 75° C. and the reaction was carried out constantly at this external temperature. After a reaction time of one hour, a further 30 g of AIBN were added. After 4 hours and again after 8 hours, dilution took place with 10.0 kg of acetone/special-boiling-point spirit 60/95 (1:1) mixture each time. To reduce the residual initiators, 90 g portions of bis(4-tert-butylcyclohexyl) peroxydicarbonate were added after 8 hours and again after 10 hours. After a reaction time of 24 hours, the reaction was discontinued and the batch was cooled to room temperature. The polyacrylate was diluted to a solids content of 30 mass percent with acetone.

### Primer PSA 3

A 100 l glass reactor conventional for radical polymerizations was charged with 6.0 kg of acrylic acid, 9.2 kg of butyl acrylate, 24.8 kg of 2-ethylhexyl acrylate, and 26.7 kg of acetone/special-boiling-point spirit 60/95 (1:1). After nitrogen gas had been passed through the reactor for 45 minutes, with stirring, the reactor was heated to 58° C. and 30 g of AIBN were added. Thereafter the external heating bath was heated to 75° C. and the reaction was carried out constantly at this external temperature. After a reaction time of one hour, a further 30 g of AIBN were added. After 4 hours and again after 8 hours, dilution took place with 10.0 kg of acetone/special-boiling-point spirit 60/95 (1:1) mixture each time. To reduce the residual initiators, 90 g portions of bis(4-tert-butylcyclohexyl) peroxydicarbonate were added after 8 hours and again after 10 hours. After a reaction time of 24 hours, the reaction was discontinued and the batch was cooled to room temperature. The polyacrylate was diluted to a solids content of 30 mass percent with acetone.

### Primer PSA 4

A 100 l glass reactor conventional for radical polymerizations was charged with 4.8 kg of acrylic acid, 10.0 kg of butyl acrylate, 22.0 kg of 2-ethylhexyl acrylate, 3.2 kg of isobornyl acrylate and 26.7 kg of acetone/special-boiling-point spirit 60/95 (1:1). After nitrogen gas had been passed through the reactor for 45 minutes, with stirring, the reactor was heated to 58° C. and 30 g of AIBN were added. Thereafter the external heating bath was heated to 75° C. and the reaction was carried out constantly at this external temperature. After a reaction time of one hour, a further 30 g of AIBN were added. After 4 hours and again after 8 hours, dilution took place with 10.0 kg of acetone/special-boiling-point spirit 60/95 (1:1) mixture each time. To reduce the residual initiators, 90 g portions of bis(4-tert-butylcyclohexyl) peroxydicarbonate were added after 8 hours and again after 10 hours. After a reaction time of 24 hours, the reaction was discontinued and the batch was cooled to room temperature. The polyacrylate was diluted to a solids content of 30 mass percent with acetone.

### Primer PSA 5 for a Comparative Example

A 100 l glass reactor conventional for radical polymerizations was charged with 0.8 kg of acrylic acid, 14.8 kg of butyl acrylate, 24.4 kg of 2-ethylhexyl acrylate, and 26.7 kg of acetone/special-boiling-point spirit 60/95 (1:1). After nitrogen gas had been passed through the reactor for 45 minutes, with stirring, the reactor was heated to 58° C. and 30 g of AIBN were added. Thereafter the external heating bath was heated to 75° C. and the reaction was carried out constantly at this external temperature. After a reaction time of one hour, a further 30 g of AIBN were added. After 4 hours and again after 8 hours, dilution took place with 10.0 kg of acetone/special-boiling-point spirit 60/95 (1:1) mixture each time. To reduce the residual initiators, 90 g portions of bis(4-tert-butylcyclohexyl) peroxydicarbonate were added after 8 hours and again after 10 hours. After a reaction time of 24 hours, the reaction was discontinued and the batch was cooled to room temperature. The polyacrylate was diluted to a solids content of 30 mass percent with acetone.

Primer PSAs 1 to 5 were briefly characterized by DMA measurements. The G′ and G″ curves of primer PSAs 1 to 5, within the deformation frequency range from 10⁰ to 10¹ rad/sec at 23° C., were always situated completely within the range from 10³ to 10⁷ Pa.

To prepare the primers of the invention, the primer PSAs described above in terms of their preparation and composition, and also the following raw materials, were used:

| Chemical compound/ | | | |
|---|---|---|---|
| description (manufacturer | | Manufacturer | |
| details) | Trade name | or supplier | CAS No. |
| Chlorinated polyolefin, chlorine | Hardlen F 6P | Toyobo | 560096-07-3 (95%), |
| content: 20%, M_{w} = 50 000, | | | 3101-60-8 (5%) |
| maleic anhydride-modified, | | | (manufacturer details) |
| maleic anhydride content: 2.0% | | | |
| Chlorinated polyolefin, chlorine | Hardlen 15-LP | Toyobo | |
| content: 30%, M_{w} = 170 000 | | | |
| Chlorinated polyolefin, acrylate- | Hardlen 163-LR | Toyobo | |
| modified, 45% solids content in | | | |
| xylene/toluene: | | | |
| Hydroxyl-containing | Desmophen A | Bayer | |
| polyacrylate, about 65% in butyl | 365 BA/X 65% | | |
| acetate/xylene 26:9 | | | |
| Titanium bis(2,4- | Tyzor AA | DuPont | 17927-72-9, |
| pentadionato)bis(2- | | | 67-63-0 |
| propanolate), 75% in | | | |
| isopropanol | | | |
| Tetra-n-butyl titanate | Tyzor TBT | DuPont | 5593-70-4 |
| Aluminum acetylacetonate | | Merck | 13963-57-0 |
| Epoxy resin based on | Epikote 828 | Hexion | 25068-38-6 |
| bisphenol A, average molecular | | | |
| weight <700 | | | |
| Glycidyloxypropyl- | Xiameter OFS-6040 | Dow Corning | 2530-83-8 |
| trimethoxysilane | Silane | | |
| 2,5-Thiophenediylbis(5-tert- | Tinopal OB | BASF | 7128-64-5 |
| butyl-1,3-benzoxazole) | | | |

Furthermore, in addition to the solvents present in the primer PSAs and primer raw materials, the following solvents were used for preparing the primers of the invention:

| | | Manufacturer or |
|---|---|---|
| Designation | CAS No. | supplier |
| Cyclohexane | 110-82-7 | Brenntag |
| Xylene | 106-42-3 | Biesterfeld |
| Ethylbenzene | 100-41-4 | Alfa Aesar |
| Ethyl acetate | 141-78-6 | Biesterfeld |
| Isopropanol | 67-63-0 | Shell |

### EXAMPLES

### Example 1

### Composition of Primer

| Raw material/Component | Mass percent |
|---|---|
| Primer PSA 1 (30 wt % solids fraction) | 14.25 |
| Tyzor AA | 0.04 |
| Hardlen F 6P | 1.50 |
| Cyclohexane | 45.07 |
| Xylene | 21.96 |
| Ethylbenzene | 4.90 |
| Isopropanol | 10.40 |
| Ethyl acetate | 1.88 |

The primer was tested in the following combinations, giving the following results:

| | | | | | | Bond strength after | |
|---|---|---|---|---|---|---|---|
| | | | | | | conditioned storage (N/cm) | |
| Test | | Bond strength (300 mm/min) | | | | a) 2 weeks | b) 2 weeks |
| adhesive | | (N/cm) | | Redetachability (30 mm/min) | | 85° C./85% | climatic |
| tape | Substrate | after 30 min | after 3 d | after 1 min | after 3 min | rel. humidity | cycling |
| 1 | PP/EPDM | 22 (40% C) | 62 (C) | adhesively | adhesively | 58 (70% C) | 59 (60% C) |
| | | | | detachable | detachable | | |
| 2 | Hot dip | 39 (50% C) | 68 (C) | adhesively | adhesively | 62 (50% C) | 58 (60% C) |
| | galvanized steel | | | detachable | detachable | | |
| 2 | ABS | 25 (40% C) | 73 (C) | adhesively | adhesively | 60 (70% C) | 63 (70% C) |
| | | | | detachable | detachable | | |
| 2 | PC | 38 (50% C) | 71 (C) | adhesively | adhesively | 66 (70% C) | 60 (80% C) |
| | | | | detachable | detachable | | |
| 2 | PVC | 31 (50% C) | 69 (C) | adhesively | adhesively | 65 (70% C) | 61 (60% C) |
| | | | | detachable | detachable | | |
| 1 | PP | 8 (A) | 25 (A) | adhesively | adhesively | 20 (20% C) | 18 (20% C) |
| | | | | detachable | detachable | | |

C = Cohesive splitting of the adhesive tape (percentage figure refers to cohesive fraction)
A = Adhesive detachment of adhesive tape from primer or of primer from substrate

### Example 2

### Composition of Primer

| Raw material/Component | Mass percent |
|---|---|
| Primer PSA 1 (30 wt % solids fraction) | 14.25 |
| Tyzor AA | 0.04 |
| Hardlen 15-LP | 1.50 |
| Cyclohexane | 45.07 |
| Xylene | 21.96 |
| Ethylbenzene | 4.90 |
| Isopropanol | 10.40 |
| Ethyl acetate | 1.88 |

The primer was tested in the following combinations, giving the following results:

| | | | | | | Bond strength after | |
|---|---|---|---|---|---|---|---|
| | | | | | | conditioned storage (N/cm) | |
| Test | | Bond strength (300 mm/min) | | | | a) 2 weeks | b) 2 weeks |
| adhesive | | (N/cm) | | Redetachability (30 mm/min) | | 85° C./85% | climatic |
| tape | Substrate | after 30 min | after 3 d | after 1 min | after 3 min | rel. humidity | cycling |
| 1 | PP/EPDM | 25 (40% C) | 64 (C) | adhesively | adhesively | 28 (10% C) | 19 (20% C) |
| | | | | detachable | detachable | | |
| 2 | Hot dip | 32 (40% C) | 65 (C) | adhesively | adhesively | 59 (20% C) | 50 (10% C) |
| | galvanized steel | | | detachable | detachable | | |
| 2 | ABS | 22 (40% C) | 69 (C) | adhesively | adhesively | 64 (20% C) | 55 (10% C) |
| | | | | detachable | detachable | | |
| 2 | PC | 33 (40% C) | 68 (C) | adhesively | adhesively | 60 (80% C) | 62 (90% C) |
| | | | | detachable | detachable | | |
| 2 | PVC | 30 (50% C) | 62 (C) | adhesively | adhesively | 35 (40% C) | 38 (40% C) |
| | | | | detachable | detachable | | |
| 1 | PP | 6 (A) | 15 (A) | adhesively | adhesively | 10 (A) | 15 (A) |
| | | | | detachable | detachable | | |

C = Cohesive splitting of the adhesive tape (percentage figure refers to cohesive fraction)
A = Adhesive detachment of adhesive tape from primer or of primer from substrate

### Example 3

### Composition of Primer

| Raw material/Component | Mass percent |
|---|---|
| Primer PSA 1 (30 wt % solids fraction) | 13.50 |
| Tyzor AA | 0.03 |
| Hardlen 163-LR | 1.50 |
| Desmophen A 365 BA/X 65% | 2.5 |
| Xiameter OFS-6040 Silane | 0.50 |
| Cyclohexane | 43.07 |
| Xylene | 21.72 |
| Ethylbenzene | 4.90 |
| Isopropanol | 10.40 |
| Ethyl acetate | 1.88 |

The primer was tested in the following combinations, giving the following results:

| | | | | | | Bond strength after | |
|---|---|---|---|---|---|---|---|
| | | | | | | conditioned storage (N/cm) | |
| Test | | Bond strength (300 mm/min) | | | | a) 2 weeks | b) 2 weeks |
| adhesive | | (N/cm) | | Redetachability (30 mm/min) | | 85° C./85% | climatic |
| tape | Substrate | after 30 min | after 3 d | after 1 min | after 3 min | rel. humidity | cycling |
| 1 | PP/EPDM | 32 (40% C) | 62 (C) | adhesively | adhesively | 55 (90% C) | 52 (90% C) |
| | | | | detachable | detachable | | |
| 2 | Hot dip | 50 (80% C) | 68 (C) | adhesively | adhesively | 60 (80% C) | 63 (90% C) |
| | galvanized steel | | | detachable | detachable | | |
| 2 | ABS | 55 (70% C) | 73 (C) | adhesively | adhesively | 65 (80% C) | 67 (90% C) |
| | | | | detachable | detachable | | |
| 2 | PC | 60 (80% C) | 71 (C) | adhesively | adhesively | 65 (90% C) | 70 (90% C) |
| | | | | detachable | detachable | | |
| 2 | PVC | 51 (90% C) | 69 (C) | adhesively | adhesively | 66 (90% C) | 64 (90% C) |
| | | | | detachable | detachable | | |
| 1 | PP | 11 (A) | 45 (10% C) | adhesively | adhesively | 32 (A) | 36 (A) |
| | | | | detachable | detachable | | |

C = Cohesive splitting of the adhesive tape (percentage figure refers to cohesive fraction)
A = Adhesive detachment of adhesive tape from primer or of primer from substrate

### Example 4

### Composition of Primer

| Raw material/Component | Mass percent |
|---|---|
| Primer PSA 1 (30 wt % solids fraction) | 13.50 |
| Tyzor AA | 0.03 |
| Hardlen F 6P | 1.50 |
| Epikote 828 | 0.20 |
| Desmophen A 365 BA/X 65% | 2.50 |
| Xiameter OFS-6040 Silane | 0.50 |
| Cyclohexane | 43.07 |
| Xylene | 21.52 |
| Ethylbenzene | 4.90 |
| Isopropanol | 10.40 |
| Ethyl acetate | 1.88 |

The primer was tested in the following combinations, giving the following results:

| | | | | | | Bond strength after | |
|---|---|---|---|---|---|---|---|
| | | | | | | conditioned storage (N/cm) | |
| Test | | Bond strength (300 mm/min) | | | | a) 2 weeks | b) 2 weeks |
| adhesive | | (N/cm) | | Redetachability (30 mm/min) | | 85° C./85% | climatic |
| tape | Substrate | after 30 min | after 3 d | after 1 min | after 3 min | rel. humidity | cycling |
| 1 | PP/EPDM | 34 (50% C) | 62 (C) | adhesively | adhesively | 55 (90% C) | 52 (90% C) |
| | | | | detachable | detachable | | |
| 2 | Hot dip | 58 (90% C) | 68 (C) | adhesively | adhesively | 60 (90% C) | 63 (90% C) |
| | galvanized steel | | | detachable | detachable | | |
| 2 | ABS | 64 (C) | 73 (C) | adhesively | adhesively | 65 (90% C) | 67 (90% C) |
| | | | | detachable | detachable | | |
| 2 | PC | 65 (C) | 71 (C) | adhesively | adhesively | 65 (90% C) | 70 (90% C) |
| | | | | detachable | detachable | | |
| 2 | PVC | 65 (C) | 69 (C) | adhesively | adhesively | 66 (90% C) | 64 (90% C) |
| | | | | detachable | detachable | | |
| 1 | PP | 16 (A) | 58 (20% C) | adhesively | adhesively | 32 (A) | 36 (A) |
| | | | | detachable | detachable | | |

C = Cohesive splitting of the adhesive tape (percentage figure refers to cohesive fraction)
A = Adhesive detachment of adhesive tape from primer or of primer from substrate

### Example 5

### Composition of Primer

| Raw material/Component | Mass percent |
|---|---|
| Primer PSA 1 (30 wt % solids fraction) | 11.20 |
| Tyzor AA | 0.02 |
| Hardlen F 6P | 1.50 |
| Epikote 828 | 0.20 |
| Desmophen A 365 BA/X 65% | 2.60 |
| Xiameter OFS-6040 Silane | 0.50 |
| Tinopal OB | 0.02 |
| Cyclohexane | 45.07 |
| Xylene | 21.96 |
| Ethylbenzene | 4.65 |
| Isopropanol | 10.40 |
| Ethyl acetate | 1.88 |

The primer was tested in the following combinations, giving the following results:

| | | | | | | Bond strength after | |
|---|---|---|---|---|---|---|---|
| | | | | | | conditioned storage (N/cm) | |
| Test | | Bond strength (300 mm/min) | | | | a) 2 weeks | b) 2 weeks |
| adhesive | | (N/cm) | | Redetachability (30 mm/min) | | 85° C./85% | climatic |
| tape | Substrate | after 30 min | after 3 d | after 1 min | after 3 min | rel. humidity | cycling |
| 1 | PP/EPDM | 36 (50% C) | 64 (C) | adhesively | adhesively | 65 (C) | 60 (C) |
| | | | | detachable | detachable | | |
| 2 | Hot dip | 65 (C) | 66 (C) | adhesively | adhesively | 63 (C) | 63 (C) |
| | galvanized steel | | | detachable | detachable | | |
| 2 | ABS | 64 (C) | 73 (C) | adhesively | adhesively | 67 (C) | 68 (90% C) |
| | | | | detachable | detachable | | |
| 2 | PC | 65 (C) | 71 (C) | adhesively | adhesively | 65 (90% C) | 68 (90% C) |
| | | | | detachable | detachable | | |
| 2 | PVC | 65 (C) | 69 (C) | adhesively | adhesively | 61 (C) | 64 (C) |
| | | | | detachable | detachable | | |
| 1 | PP | 21 (10% C) | 59 (30% C) | adhesively | adhesively | 52 (10% C) | 56 (20% C) |
| | | | | detachable | detachable | | |

C = Cohesive splitting of the adhesive tape (percentage figure refers to cohesive fraction)
A = Adhesive detachment of adhesive tape from primer or of primer from substrate

### Example 6

### Composition of Primer

| Raw material/Component | Mass percent |
|---|---|
| Primer PSA 2 (30 wt % solids fraction) | 11.20 |
| Aluminum acetylacetonate | 0.02 |
| Hardlen F 6P | 1.50 |
| Epikote 828 | 0.20 |
| Desmophen A 365 BA/X 65% | 2.60 |
| Xiameter OFS-6040 Silane | 0.50 |
| Tinopal OB | 0.02 |
| Cyclohexane | 45.07 |
| Xylene | 21.96 |
| Ethylbenzene | 4.65 |
| Isopropanol | 10.40 |
| Ethyl acetate | 1.88 |

The primer was tested in the following combinations, giving the following results:

| | | | | | | Bond strength after | |
|---|---|---|---|---|---|---|---|
| | | | | | | conditioned storage (N/cm) | |
| Test | | Bond strength (300 mm/min) | | | | a) 2 weeks | b) 2 weeks |
| adhesive | | (N/cm) | | Redetachability (30 mm/min) | | 85° C./85% | climatic |
| tape | Substrate | after 30 min | after 3 d | after 1 min | after 3 min | rel. humidity | cycling |
| 1 | PP/EPDM | 31 (20% C) | 68 (C) | adhesively | adhesively | 60 (C) | 57 (C) |
| | | | | detachable | detachable | | |
| 2 | Hot dip | 63 (C) | 64 (C) | adhesively | adhesively | 60 (C) | 65 (C) |
| | galvanized steel | | | detachable | detachable | | |
| 2 | ABS | 65 (C) | 68 (C) | adhesively | adhesively | 62 (80% C) | 62 (80% C) |
| | | | | detachable | detachable | | |
| 2 | PC | 66 (C) | 70 (C) | adhesively | adhesively | 64 (90% C) | 60 (90% C) |
| | | | | detachable | detachable | | |
| 2 | PVC | 62 (C) | 68 (C) | adhesively | adhesively | 59 (90% C) | 60 (90% C) |
| | | | | detachable | detachable | | |
| 1 | PP | 10 (A) | 50 (20% C) | adhesively | adhesively | 42 (A) | 49 (A) |
| | | | | detachable | detachable | | |

C = Cohesive splitting of the adhesive tape (percentage figure refers to cohesive fraction)
A = Adhesive detachment of adhesive tape from primer or of primer from substrate

### Example 7

### Composition of Primer

| Raw material/Component | Mass percent |
|---|---|
| Primer PSA 3 (30 wt % solids fraction) | 11.20 |
| Aluminum acetylacetonate | 0.02 |
| Hardlen F 6P | 1.50 |
| Epikote 828 | 0.20 |
| Desmophen A 365 BA/X 65% | 2.60 |
| Xiameter OFS-6040 Silane | 0.50 |
| Tinopal OB | 0.02 |
| Cyclohexane | 45.07 |
| Xylene | 21.96 |
| Ethylbenzene | 4.65 |
| Isopropanol | 10.40 |
| Ethyl acetate | 1.88 |

The primer was tested in the following combinations, giving the following results:

| | | | | | | Bond strength after | |
|---|---|---|---|---|---|---|---|
| | | | | | | conditioned storage (N/cm) | |
| Test | | Bond strength (300 mm/min) | | | | a) 2 weeks | b) 2 weeks |
| adhesive | | (N/cm) | | Redetachability (30 mm/min) | | 85° C./85% | climatic |
| tape | Substrate | after 30 min | after 3 d | after 1 min | after 3 min | rel. humidity | cycling |
| 1 | PP/EPDM | 29 (10% C) | 71 (C) | adhesively | adhesively | 48 (90% C) | 51 (90% C) |
| | | | | detachable | detachable | | |
| 2 | Hot dip | 65 (C) | 68 (C) | adhesively | adhesively | 62 (C) | 63 (C) |
| | galvanized steel | | | detachable | detachable | | |
| 2 | ABS | 68 (C) | 69 (C) | adhesively | adhesively | 60 (70% C) | 66 (80% C) |
| | | | | detachable | detachable | | |
| 2 | PC | 63 (C) | 66 (C) | adhesively | adhesively | 61 (80% C) | 63 (80% C) |
| | | | | detachable | detachable | | |
| 2 | PVC | 65 (C) | 71 (C) | adhesively | adhesively | 61 (90% C) | 63 (C) |
| | | | | detachable | detachable | | |
| 1 | PP | 13 (A) | 44 (10% C) | adhesively | adhesively | 32 (A) | 29 (A) |
| | | | | detachable | detachable | | |

C = Cohesive splitting of the adhesive tape (percentage figure refers to cohesive fraction)
A = Adhesive detachment of adhesive tape from primer or of primer from substrate

### Example 8

### Composition of Primer

| Raw material/Component | Mass percent |
|---|---|
| Primer PSA 4 (30 wt % solids fraction) | 11.20 |
| Tyzor AA | 0.02 |
| Hardlen F 6P | 1.50 |
| Epikote 828 | 0.20 |
| Desmophen A 365 BA/X 65% | 2.60 |
| Xiameter OFS-6040 Silane | 0.50 |
| Cyclohexane | 45.09 |
| Xylene | 21.96 |
| Ethylbenzene | 4.65 |
| Isopropanol | 10.40 |
| Ethyl acetate | 1.88 |

The primer was tested in the following combinations, giving the following results:

| | | | | | | Bond strength after | |
|---|---|---|---|---|---|---|---|
| | | | | | | conditioned storage (N/cm) | |
| Test | | Bond strength (300 mm/min) | | | | a) 2 weeks | b) 2 weeks |
| adhesive | | (N/cm) | | Redetachability (30 mm/min) | | 85° C./85% | climatic |
| tape | Substrate | after 30 min | after 3 d | after 1 min | after 3 min | rel. humidity | cycling |
| 1 | PP/EPDM | 31 (20% C) | 66 (C) | adhesively | adhesively | 64 (C) | 63 (C) |
| | | | | detachable | detachable | | |
| 2 | Hot dip | 61 (C) | 68 (C) | adhesively | adhesively | 67 (C) | 59 (C) |
| | galvanized steel | | | detachable | detachable | | |
| 2 | ABS | 60 (C) | 69 (C) | adhesively | adhesively | 59 (C) | 55 (90% C) |
| | | | | detachable | detachable | | |
| 2 | PC | 66 (C) | 65 (C) | adhesively | adhesively | 60 (C) | 62 (C) |
| | | | | detachable | detachable | | |
| 2 | PVC | 67 (C) | 65 (C) | adhesively | adhesively | 59 (90% C) | 58 (90% C) |
| | | | | detachable | detachable | | |
| 1 | PP | 25 (A) | 62 (10% C) | adhesively | adhesively | 42 (10% C) | 46 (A) |
| | | | | detachable | detachable | | |

C = Cohesive splitting of the adhesive tape (percentage figure refers to cohesive fraction)
A = Adhesive detachment of adhesive tape from primer or of primer from substrate

### Example 9

### Composition of Primer

| Raw material/Component | Mass percent |
|---|---|
| Primer PSA 1 (30 wt % solids fraction) | 11.90 |
| Tyzor AA | 0.02 |
| Hardlen F 6P | 1.50 |
| Desmophen A 365 BA/X 65% | 2.60 |
| Cyclohexane | 45.09 |
| Xylene | 21.96 |
| Ethylbenzene | 4.65 |
| Isopropanol | 10.40 |
| Ethyl acetate | 1.88 |

The primer was tested in the following combinations, giving the following results:

| | | | | | | Bond strength after | |
|---|---|---|---|---|---|---|---|
| | | | | | | conditioned storage (N/cm) | |
| Test | | Bond strength (300 mm/min) | | | | a) 2 weeks | b) 2 weeks |
| adhesive | | (N/cm) | | Redetachability (30 mm/min) | | 85° C./85% | climatic |
| tape | Substrate | after 30 min | after 3 d | after 1 min | after 3 min | rel. humidity | cycling |
| 1 | PP/EPDM | 25 (30% C) | 60 (C) | adhesively | adhesively | 65 (C) | 63 (C) |
| | | | | detachable | detachable | | |
| 2 | Hot dip | 61 (C) | 62 (C) | adhesively | adhesively | 68 (C) | 69 (C) |
| | galvanized steel | | | detachable | detachable | | |
| 2 | ABS | 67 (C) | 70 (C) | adhesively | adhesively | 62 (C) | 66 (90% C) |
| | | | | detachable | detachable | | |
| 2 | PC | 71 (C) | 64 (C) | adhesively | adhesively | 57 (80% C) | 60 (80% C) |
| | | | | detachable | detachable | | |
| 2 | PVC | 70 (C) | 65 (C) | adhesively | adhesively | 52 (70% C) | 49 (60% C) |
| | | | | detachable | detachable | | |
| 1 | PP | 15 (A) | 61 (10% C) | adhesively | adhesively | 49 (10% C) | 56 (20% C) |
| | | | | detachable | detachable | | |

C = Cohesive splitting of the adhesive tape (percentage figure refers to cohesive fraction)
A = Adhesive detachment of adhesive tape from primer or of primer from substrate

### Example 10

### Composition of Primer

| Raw material/Component | Mass percent |
|---|---|
| Primer PSA 1 (30 wt % solids fraction) | 13.00 |
| Tyzor AA | 0.03 |
| Hardlen F 6P | 1.50 |
| Xiameter OFS-6040 Silane | 0.50 |
| Cyclohexane | 45.08 |
| Xylene | 22.96 |
| Ethylbenzene | 4.65 |
| Isopropanol | 10.40 |
| Ethyl acetate | 1.88 |

The primer was tested in the following combinations, giving the following results:

| | | | | | | Bond strength after | |
|---|---|---|---|---|---|---|---|
| | | | | | | conditioned storage (N/cm) | |
| Test | | Bond strength (300 mm/min) | | | | a) 2 weeks | b) 2 weeks |
| adhesive | | (N/cm) | | Redetachability (30 mm/min) | | 85° C./85% | climatic |
| tape | Substrate | after 30 min | after 3 d | after 1 min | after 3 min | rel. humidity | cycling |
| 1 | PP/EPDM | 20 (10% C) | 62 (C) | adhesively | adhesively | 60 (C) | 59 (C) |
| | | | | detachable | detachable | | |
| 2 | Hot dip | 59 (C) | 65 (C) | adhesively | adhesively | 59 (C) | 58 (C) |
| | galvanized steel | | | detachable | detachable | | |
| 2 | ABS | 62 (C) | 66 (C) | adhesively | adhesively | 57 (C) | 65 (C) |
| | | | | detachable | detachable | | |
| 2 | PC | 65 (C) | 63 (C) | adhesively | adhesively | 62 (80% C) | 55 (70% C) |
| | | | | detachable | detachable | | |
| 2 | PVC | 72 (C) | 66 (C) | adhesively | adhesively | 61 (70% C) | 61 (90% C) |
| | | | | detachable | detachable | | |
| 1 | PP | 10 (A) | 45 (C) | adhesively | adhesively | 28 (A) | 36 (10% C) |
| | | | | detachable | detachable | | |

C = Cohesive splitting of the adhesive tape (percentage figure refers to cohesive fraction)
A = Adhesive detachment of adhesive tape from primer or of primer from substrate

### Example 11

### Composition of Primer

| Raw material/Component | Mass percent |
|---|---|
| Primer PSA 1 (30 wt % solids fraction) | 13.00 |
| Tyzor AA | 0.03 |
| Hardlen F 6P | 1.50 |
| Epikote 828 | 0.20 |
| Cyclohexane | 45.08 |
| Xylene | 22.96 |
| Ethylbenzene | 4.65 |
| Isopropanol | 10.70 |
| Ethyl acetate | 1.88 |

The primer was tested in the following combinations, giving the following results:

| | | | | | | Bond strength after | |
|---|---|---|---|---|---|---|---|
| | | | | | | conditioned storage (N/cm) | |
| Test | | Bond strength (300 mm/min) | | | | a) 2 weeks | b) 2 weeks |
| adhesive | | (N/cm) | | Redetachability (30 mm/min) | | 85° C./85% | climatic |
| tape | Substrate | after 30 min | after 3 d | after 1 min | after 3 min | rel. humidity | cycling |
| 1 | PP/EPDM | 18 (A) | 65 (C) | adhesively | adhesively | 66 (C) | 62 (C) |
| | | | | detachable | detachable | | |
| 2 | Hot dip | 61 (C) | 65 (C) | adhesively | adhesively | 64 (C) | 58 (C) |
| | galvanized steel | | | detachable | detachable | | |
| 2 | ABS | 66 (C) | 66 (C) | adhesively | adhesively | 59 (C) | 61 (C) |
| | | | | detachable | detachable | | |
| 2 | PC | 64 (C) | 73 (C) | adhesively | adhesively | 54 (80% C) | 61 (70% C) |
| | | | | detachable | detachable | | |
| 2 | PVC | 69 (C) | 70 (C) | adhesively | adhesively | 57 (70% C) | 55 (60% C) |
| | | | | detachable | detachable | | |
| 1 | PP | 22 (A) | 55 (10% C) | adhesively | adhesively | 58 (10% C) | 46 (10% C) |
| | | | | detachable | detachable | | |

C = Cohesive splitting of the adhesive tape (percentage figure refers to cohesive fraction)
A = Adhesive detachment of adhesive tape from primer or of primer from substrate

### Comparative Example 1

### Composition of Comparative Primer

| Raw material/Component | Mass percent |
|---|---|
| Primer PSA 1 (30 wt % solids fraction) | 13.00 |
| Hardlen F 6P | 1.50 |
| Epikote 828 | 0.20 |
| Cyclohexane | 45.11 |
| Xylene | 22.96 |
| Ethylbenzene | 4.65 |
| Isopropanol | 10.70 |
| Ethyl acetate | 1.88 |

The primer was tested in the following combinations, giving the following results:

| | | | | Redetachability | |
|---|---|---|---|---|---|
| Test | | Bond strength | | (30 mm/min) | |
| adhesive | | (300 mm/min) (N/cm) | | after | |
| tape | Substrate | after 30 min | after 3 d | 1 min | after 3 min |
| 1 | PP/EPDM | 4 (A) | 6 (A) | adhesively | adhesively |
| | | | | detachable | detachable |
| 2 | Hot dip | 3 (A) | 5 (A) | adhesively | adhesively |
| | galvanized | | | detachable | detachable |
| | steel | | | | |

C = Cohesive splitting of the adhesive tape (percentage figure refers to cohesive fraction)
A = Adhesive detachment of adhesive tape from primer or of primer from substrate

### Comparative Example 2

### Composition of Comparative Primer

| Raw material/Component | Mass percent |
|---|---|
| Primer PSA 1 (30 wt % solids fraction) | 13.00 |
| Tyzor AA | 1.00 |
| Hardlen F 6P | 1.50 |
| Epikote 828 | 0.20 |
| Cyclohexane | 45.01 |
| Xylene | 22.96 |
| Ethylbenzene | 4.65 |
| Isopropanol | 10.70 |
| Ethyl acetate | 1.88 |

The primer was tested in the following combinations, giving the following results:

| | | Bond strength | | Redetachability | |
|---|---|---|---|---|---|
| Test | | (300 mm/min) | | (30 mm/min) | |
| adhesive | | (N/cm) | | after | |
| tape | Substrate | after 30 min | after 3 d | 1 min | after 3 min |
| 1 | PP/EPDM | 6 (A) | 9 (A) | adhesively | adhesively |
| | | | | detachable | detachable |
| 2 | Hot dip | 5 (A) | 8 (A) | adhesively | adhesively |
| | galvanized | | | detachable | detachable |
| | steel | | | | |

C = Cohesive splitting of the adhesive tape (percentage figure refers to cohesive fraction)
A = Adhesive detachment of adhesive tape from primer or of primer from substrate

### Comparative Example 3

### Composition of Comparative Primer

| Raw material/Component | Mass percent |
|---|---|
| Primer PSA 5 (30 wt % solids fraction) | 13.00 |
| Tyzor AA | 0.03 |
| Hardlen F 6P | 1.50 |
| Epikote 828 | 0.20 |
| Cyclohexane | 45.41 |
| Xylene | 22.63 |
| Ethylbenzene | 4.65 |
| Isopropanol | 10.70 |
| Ethyl acetate | 1.88 |

The primer was tested in the following combinations, giving the following results:

| | | Bond strength | | Redetachability | |
|---|---|---|---|---|---|
| Test | | (300 mm/min) | | (30 mm/min) | |
| adhesive | | (N/cm) | | after | |
| tape | Substrate | after 30 min | after 3 d | 1 min | after 3 min |
| 1 | PP/EPDM | 2 (A) | 7 (A) | adhesively | adhesively |
| | | | | detachable | detachable |
| 2 | Hot dip | 4 (A) | 6 (A) | adhesively | adhesively |
| | galvanized | | | detachable | detachable |
| | steel | | | | |

C = Cohesive splitting of the adhesive tape (percentage figure refers to cohesive fraction)
A = Adhesive detachment of adhesive tape from primer or of primer from substrate

1. A primer comprising a mixture, in dispersion or solution in one or more solvents, of
I) a pressure-sensitive adhesive comprising at least one base polymer component obtained by radical copolymerization of the following monomers:
a) at least one acrylic ester of a linear, primary alcohol having 2 to 10 carbon atoms in the alcohol alkyl radical,
b) at least one acrylic ester of a branched, noncyclic alcohol having 4 to 12 carbon atoms in the alcohol alkyl radical,
c) 8 to 15 mass percent of acrylic acid, based on the sum of the monomers,
d) optionally up to 10 mass percent of other copolymerizable monomers, based on the sum of the monomers,
II) at least one thermal crosslinker based on a metal acetylacetonate, a metal alkoxide, or an alkoxy-metal acetylacetonate,
III) at least one chlorinated polyolefin,
wherein
the concentration of the thermal crosslinkers, based on the sum of the base polymer components of the pressure-sensitive adhesive, is in the range of from 0.05 mass percent to 5.0 mass percent.

2. The primer of claim 1, wherein
the chlorinated polyolefin is modified with an α,β-unsaturated carboxylic acid or anhydride thereof and/or with an acrylate.

3. The primer of claim 1, wherein
the ratio of the sum of the acrylic esters of linear, primary alcohol to the sum of the acrylic esters of branched, noncyclic alcohol is in the range of from 10:90 to 90:10 mass fractions.

4. The primer of claim 1, wherein
the at least one base polymer component makes up at least 90 mass percent of the pressure-sensitive adhesive, or, if there are two or more base polymer components based on components I)a) to I)d), the sum of the base polymer components makes up at least 90 mass percent of the pressure-sensitive adhesive.

5. The primer of claim 1, wherein
the ratio of the sum of the base polymer component of the pressure-sensitive adhesive to the sum of the chlorinated polyolefins in the mixture is in the range from 30:70 to 95:5 mass fractions.

6. The primer of claim 1, wherein the mixture is free from block copolymers of the polystyrene/polydiene or polystyrene/hydrogenated polydiene type.

7. The primer of claim 1, wherein
the metal of the thermal crosslinker is titanium, aluminum, zirconium, zinc or iron.

8. The primer of claim 1, wherein
the mixture further comprises one or more epoxy resins.

9. The primer of claim 1, wherein
the mixture further comprises one or more styrene acrylate resins.

10. The primer of claim 1, wherein
the mixture further comprises one or more organofunctional silanes.

11. The primer of claim 1, wherein
the mixture further comprises one or more fluorescent optical brighteners.

12. The primer of claim 1, wherein
the concentration of the mixture in the one or more solvents is in the range of from 0.1 to a maximum of 30 mass percent.

13. The primer of claim 1, wherein
said one or more solvents are organic solvents.

14. The primer of claim 1, wherein
one of the solvents is isopropanol or another alcohol.

15. Method for producing an adhesion-promoting layer which comprises forming said adhesion-promoting layer with the primer of claim 1.

16. A method for producing an adhesion-promoting layer on a substrate, comprising
applying the primer of claim 1 to a substrate, and causing or allowing the evaporation of said one or more solvents.
